(19) United States
(12) Patent Application Publication
(10) Pub. No.: US 2015/0121819 A1
(43) Pub. Date: May 7, 2015

(54) STIRRUP COMPRISING A TREAD

(71) Applicants: Valentin Vollmecke, Iserlohn (DE); Heinz Baumann, Iserlohn (DE); Brigitte Schulte, Iserlohn (DE)

(72) Inventors: Valentin Vollmecke, Iserlohn (DE); Heinz Baumann, Iserlohn (DE); Brigitte Schulte, Iserlohn (DE)

(73) Assignee: HERM. SPRENGER GMBH & CO KG, Iserlohn (DE)

(21) Appl. No.: 12/293,403

(22) PCT Filed: Mar. 1, 2007
(86) PCT No.: PCT/EP2007/051965

§ 371 Date: Sep. 17, 2008

(30) Foreign Application Priority Data
Mar. 17, 2006 (DE) 10 2006 012 704.8
Aug. 11, 2008 (DE) 10 2006 038 317.6

(51) Int. Cl. B68C 3/00

(52) U.S. Cl. CPC B68C 3/00; B68C 2003/0083
USPC 54/49

(57) ABSTRACT

The invention relates to a stirrup comprising a tread (20) and an arch (22) which is connected thereto, said arch comprising two lateral extensions (24, 26) and on upper eye area (28) in which an eye (29) is provided. Said eye area (28) extends at an angle of 15 to 40 degrees, preferably approximately 25 degrees, to a longitudinal plane (34) which is defined by a longitudinal axis (36) of the tread (20) and which extends at a right angle to said tread (20).

### TECHNICAL FIELD OF THE INVENTION

The invention relates to a stirrup comprising a tread and an arch which is connected thereto, said arch comprising two lateral extensions and one upper eye area in which an eye is provided.

### BRIEF DISCUSSION OF RELATED ART

Such a stirrup is known from EP 1 003 688 B1. On the prior art stirrup, the eye area is located in the longitudinal plane. On the stirrup known from U.S. Pat. No. 143,732 (1873), the eye area is located in a transverse plane that extends at an angle of 90° with respect to the longitudinal plane and is a symmetry plane of the stirrup.

A stirrup is known from EP 0 796 816 B1 wherein the eye area is rotatably connected to this arch so that it can be oriented in different angular positions with respect to the longitudinal plane. This stirrup is of a complex construction and there is the risk that the eye area detaches from the arch, thus leading to momentous accidents.

### BRIEF SUMMARY OF THE INVENTION

The invention provides a stirrup in which, like in the document EP 1 003 688 B1, the eye area is rigidly connected to the lateral extensions and that is more easy to get in during riding. In view of the stirrup of the type mentioned herein above, this is achieved in that the eye area extends at an angle of 15 to 40°, preferably of about 25°, with respect to a longitudinal plane that is defined by a longitudinal axis of the tread and is perpendicular to said tread. In particular, the eye area is oriented at an angle of 20 to 35° with respect to the longitudinal plane.

Unlike the stirrup according to the document EP 1 003 688 B1, the eye area is not in the longitudinal plane but is rotated at an angle in the angular range indicated with respect thereto. As a result, two different stirrups are formed, namely a left stirrup in which the rotation of the eye area occurs in the mathematically positive sense (and, as a result thereof, anticlockwise) and a right stirrup in which the curve is in the mathematical negative sense. On a saddled horse, these stirrups are hung for the longitudinal plane not to be parallel to the longitudinal direction of the horse and, as a result thereof, to the flanks, but so that the longitudinal planes of the two stirrups intersect in front of the horse. The treads are slightly inclined, each stirrup offering a foot engaging therein from behind a certain if not complete opening. It suffices for the front part of the foot to engage therein. Whilst the stirrup is being put into place, it rotates outward.

The stirrup of the invention offers significant advantages for riding. It is particularly suited for English riding. It shows a calmer position on the horse. By virtue of the angular position of the eye area, the stirrup fits more snugly against the foot. On load, the arch adopts a comfortable position. It is better adapted to the horse's anatomy. In practical use, the arch is straight and uniform underneath the ball of the foot whilst the arch of the type mentioned herein above is slightly inclined.

In a preferred developed implementation, the eye has a center point. This center point is located on the longitudinal plane. Put another way, the center point of the eye is located on a mean perpendicular of the tread. In this way, the arch hangs straight downward. The center of gravity of the arch is located on the longitudinal plane and also on a mean perpendicular.

Preferably, the eye area itself is not curved but planar, which means that it is located in one plane. The curvature needed to achieve the angular position between the eye area and the tread is given by the deformation of the lateral extensions. Preferably, the two lateral extensions are equally shaped. As a result, the stirrup has 180 degree rotational symmetry about the mean perpendicular.

The stirrup of the invention is preferably suited to form hinge regions in its lateral extensions. Such type hinge regions are already known, the reader being again referred to the document EP 1 003 688 B1. The hinge regions disclosed therein can also be provided for in the stirrup of the invention. The swivel axes of the hinge regions preferably lie in the longitudinal plane and the curvature of the extensions only occurs above the hinge regions, meaning in that part of the extensions that is located above the hinge regions.

### BRIEF DESCRIPTION OF THE DRAWINGS

Other features and advantages of the invention will become more apparent upon reviewing the appended claims and the following non restrictive description of one embodiment of the invention, given by way of example only with reference to the drawing. In said drawing:

FIG. 1: is a front view of the stirrup,

FIG. 2: is a side view of the stirrup, meaning that it is rotated 90° with respect to FIG. 1,

FIG. 3: is a top view from above of the stirrup,

FIG. 4: is an illustration like FIG. 1 of the upper portion of the arch with respective connecting areas and partially sectional,

FIG. 5: is a view like FIG. 2 of only the upper region of the arch as it is also shown in FIG. 4,

FIG. 6: is an view from beneath of the arch part shown in FIG. 4,

FIG. 7: is an illustration like FIG. 4 but now for a left stirrup,

FIG. 8: is an illustration like FIG. 5, but for the left stirrup according to FIG. 7,

FIG. 9: is an illustration like FIG. 6, but now for the left stirrup according to FIG. 7,

FIG. 10: is a sectional view of the tread without rubber insert and through the lower portions of the extensions, the section plane is the longitudinal plane,

FIG. 11: is a section taken along section line XI-XI in FIG. 10 and

FIG. 12: is an top view in the negative y direction of the tread according to FIG. 10 and also without rubber insert.

### DETAILED DESCRIPTION OF THE INVENTION

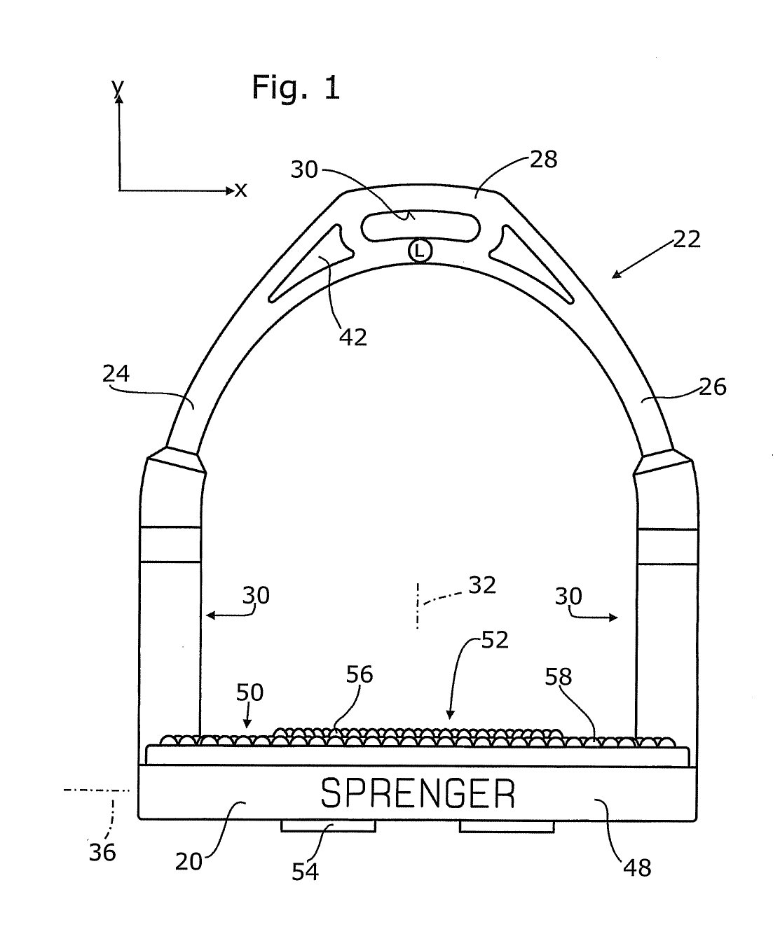

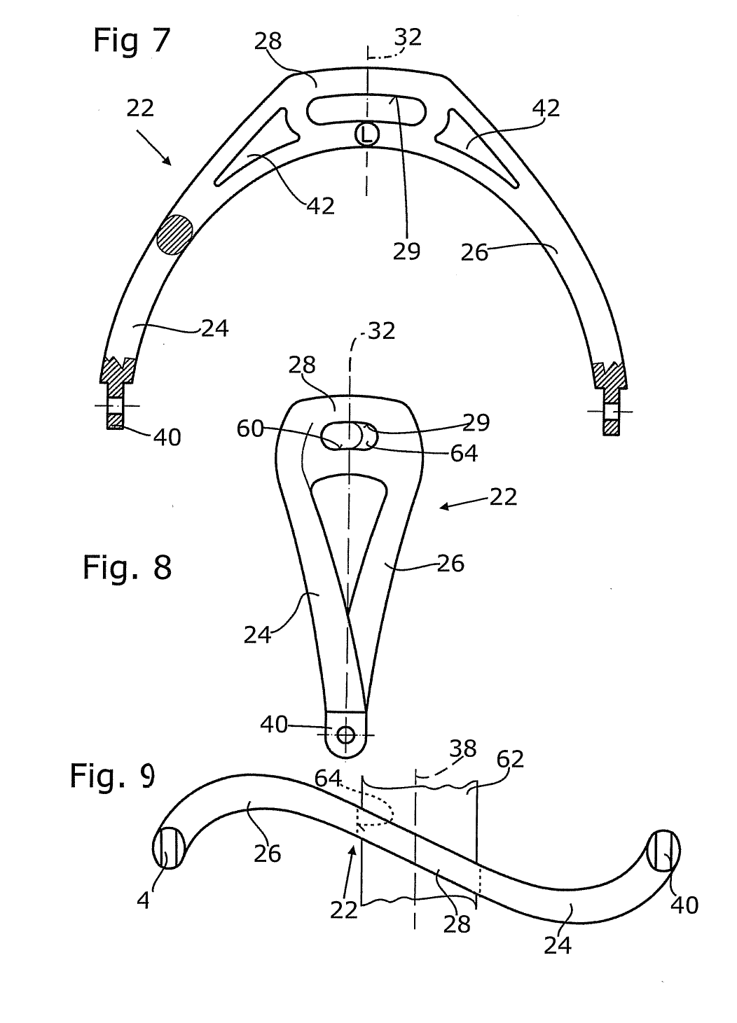

A left stirrup as it is comprehensively illustrated in the FIGS. 1 through 3 and is moreover shown in parts in the FIGS. 7 through 12 has a tread 20 that forms a rest for a boot that has not been illustrated herein and an arch 22 that is connected to said tread 20. This arch 22 has two lateral extensions 24, 26 and one upper eye area 28. In said upper eye area, there is provided an eye 29 which is also referred to as a stirrup strap eye. It has the shape of a long hole. In the exemplary embodiment shown, its width is approximately about 5 times its height. It is configured according to prior art. The eye 29 can also be configured different from shown insofar as it only serves for fastening the stirrup to a strap or the like.

In their lower part, the two extensions 24, 26 are provided with a hinge region 30. For forming this hinge region 30 the reader is referred to the already mentioned document EP 1 003 688 B1, more specifically to the three Figs. of this patent document.

The stirrup has rotational symmetry with respect to a mean perpendicular 32 of the tread 20, the symmetry is 180° . This mean perpendicular 32 lies in the longitudinal plane 34. The longitudinal plane 34 is moreover defined by a longitudinal axis 36 of the tread 20 which joins together the center of the base points of the two extensions 24, 26. The longitudinal plane 34 is at the same time a plane of symmetry for the tread 20. In FIG. 1, the longitudinal plane 34 lies in the plane of the paper.

The eye area 28 is curved at an angle of plus 25° with respect to this longitudinal plane 34 or to the longitudinal plane 36. The eye area 28 itself is not curved, but lies in a plane instead. In an alternative, it is possible to also curve the eye area 28.

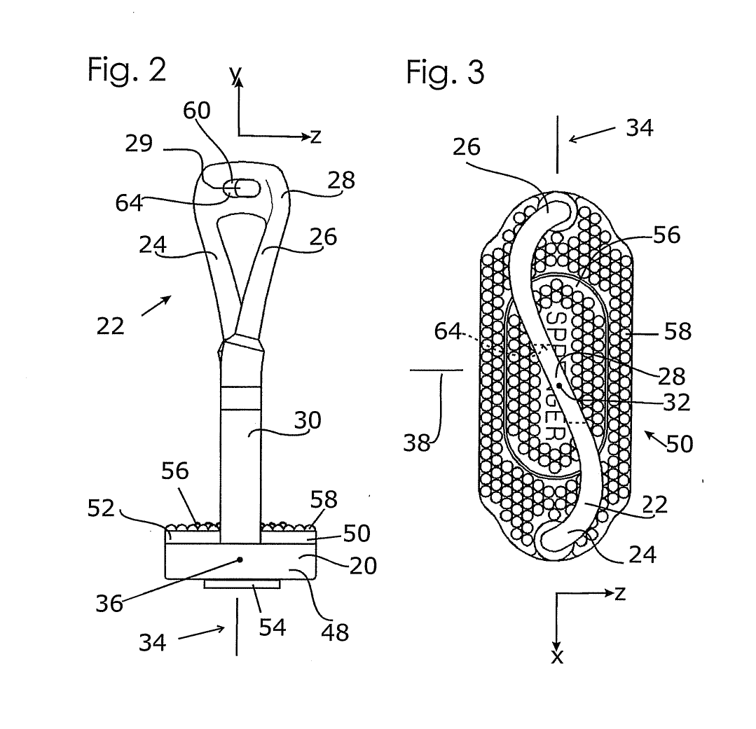

In order to achieve the described angular position of the eye area 28, the lateral extensions 24, 26 are curved, as can be seen best from the FIGS. 2 and 3. The bending thereby occurs between the hinge regions 30 and the eye area 28.

In view of the stirrup of the type mentioned herein above according to EP 1 003 688 B1, the described angular position of the eye area 28 can occur by bending the eye area 28 in the mathematically positive sense or in the mathematically negative sense. In this way, two different stirrups are obtained. If the curvature is in the mathematically positive sense, one obtains a left stirrup, if the curvature is in the mathematically negative sense (and clockwise), one obtains a right stirrup.

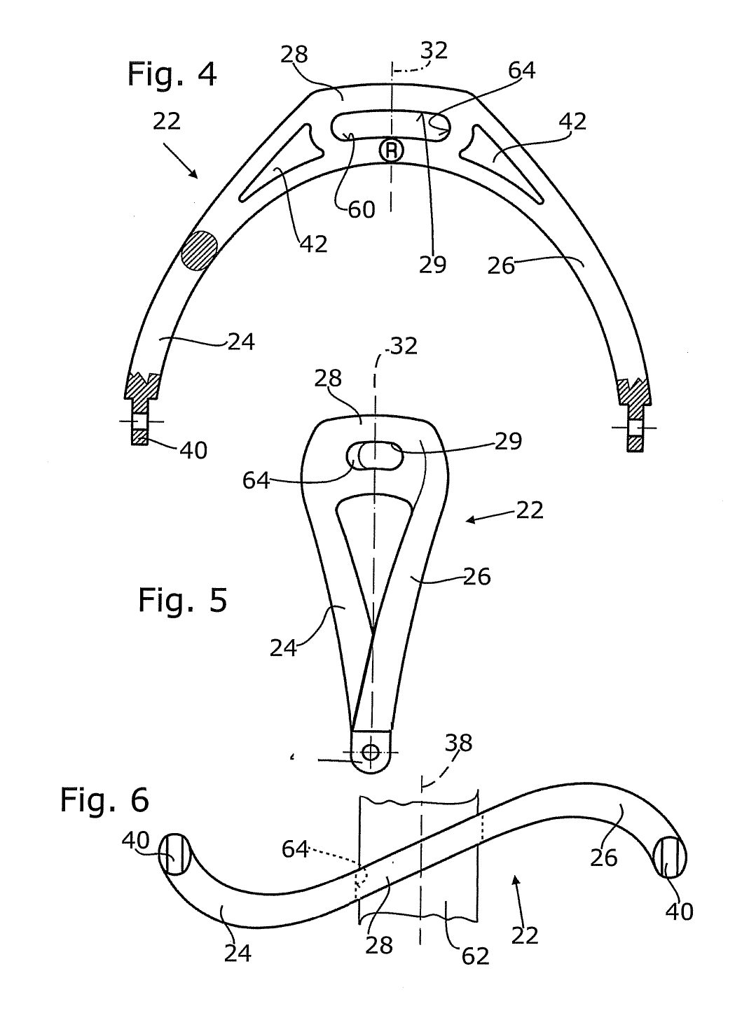

If the stirrup is fastened to a saddle, it does not matter which one of the two extensions 24, 26 is pointing forward, the position obtained is always the correct one. Like in the prior art stirrup of the type mentioned herein above, there is no difference between front and back. As contrasted to this stirrup according to EP 1 003 688 B1, there is however the mentioned difference between left and right. The two stirrups are also marked accordingly; see FIGS. 1 and 4 for the right stirrup and FIG. 7 for the left stirrup.

The FIGS. 1 through 3 also show a right-angled coordinate system x, y, z in order to garner a better understanding of the stirrup. The longitudinal plane 34 lies in the x-y plane. It extends centrally through the stirrup. A transverse plane 38 extends in the y-z plane. Like the longitudinal plane 34, the transverse plane 38 is also a symmetry plane of the tread 20. It should be noted that, in contrast to the drawing in the FIGS. 1 through 3, the center of this coordinate system is in the center of the tread 20, meaning at the intersection between the longitudinal axis 36 and the mean perpendicular 32. The longitudinal axis 36 lies on the x axis. The mean perpendicular 32 lies on the y axis.

As shown in the top view shown in FIG. 3, the arch 22 extends in an S shape in the top view shown. In contrast thereto, it bends in Z shape in the right stirrup as can be seen in parts only in the FIGS. 4 through 6, and the eye area 28 is rotated minus 25° in the mathematical sense and as a result thereof 25° clockwise with respect to the stirrup according to EP 1 003 688 B1.

In the FIGS. 4 through 6 for the right stirrup and in the FIGS. 7 through 9 for the left stirrup the respective upper parts of the arch 22 are shown in different views. Each of these parts ends in connecting regions 40 as they are known from EP 1 003 688 B1. The holes in the connecting regions 40 can be seen. They define one of the several parallel articulation axes of the hinge region 30.

Beside the eye 29, on the left and the right side thereof, there is a respective window 42. The two windows 42 have the same shape. They have approximately the shape of a triangle. They make it possible to save weight.

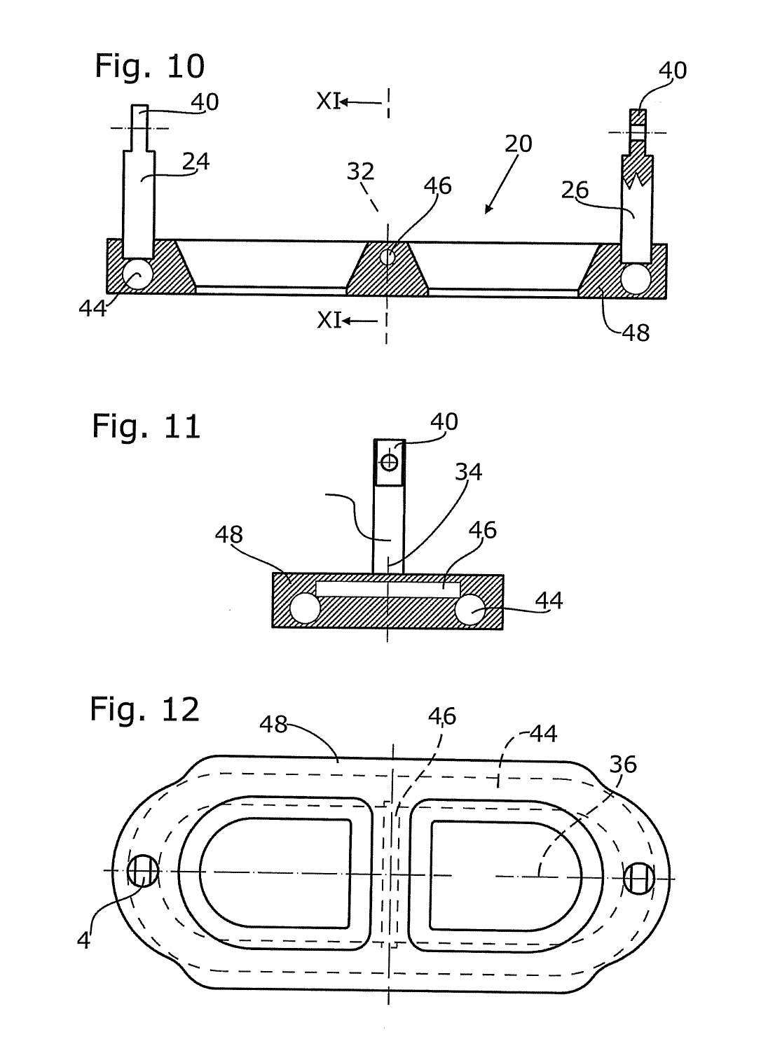

The tread 20 is built as follows: it has a carrier part 44 made from a round material. The diameter of the round material corresponds to the diameter of the extensions 24, 26 in their lowest part as shown for example in the FIGS. 10 and 12. The carrier part 44 is curved into an oval shape, precisely, it consists of two half circles and of rectilinear portions for connecting said half circles. In the apex of a respective one of the semi-circular regions it is connected to lower end pieces of the extensions 24, 26. The connection can be through welding, screwing or the like. Additionally, the carrier part 44 has a cross member 46 that joins the rectilinear portions together in their center. It is made from a thinner round material, for example with 30-50% of the diameter of the material of the carrier part 44. It is placed on top of the cross member 46 and is welded thereto at its ends.

Plastic material is molded around carrier part 44 and cross member 46 as well as around the lowermost end regions of the lower portions of the extensions 24, 26 so that a plastic body is formed having approximately the shape of an 8. His shape can be seen from the FIGS. 10 through 12. This construction allows weight saving. At the same time, the connection points are protected. The plastic body 48 has a level top side and a level underside, both are parallel to the x-z plane.

In an actually known manner, a rubber insert 50 is clipped into the thus formed tread 20; it is shown in FIG. 3. It is formed from a suited elastomer material. It forms an integral upper rest region 52 and adjoining arms with projections 54, said projections engaging underneath the underside of the tread and securing the rubber insert 50 into place.

Unlike prior art, this rubber insert 50, preferably the rest region 52 only, is now implemented as follows: the rubber insert 50 consists of two different materials, namely an inner region 56 and an outer region 58. The inner region 56 projects a few millimeters, for example 0.5 to 5 mm, in the y direction, meaning upward, beyond the outer region 58. This can be seen in FIG. 2 for example. The inner region 56 and the outer region 58 are preferably structured, for example with studs or other local projections as can be seen from the FIGS. 2 and 3. The inner region 56 is made from a material that is at least 10 degrees of Shore hardness, preferably at least 20 degrees of Shore hardness, softer than the material of the outer region 58. The material of the inner region 56 preferably has a Shore hardness of 20 to 50, more specifically of 42 to 45. The material of the outer region preferably has a Shore hardness of 50 to 90, more specifically of about 66. The hardness of the outer region corresponds to the hardness of the stirrup inserts as offered by the applicant for the stirrup according to EP 1 003 688 B1.

The eye 29 is limited by an annular circumferential inner wall 60. This inner wall has two side faces 64 opposing each other in the x direction and also two main faces that oppose each other in the y direction. A stirrup strap 62 abuts these faces when it is threaded through the eye 29, see FIGS. 6 and 9. The side faces 64 extend in the y-z plane. Accordingly, they are inclined at an angle with respect to the eye area 28, said angle corresponding to the rotation of the eye area about an angle of 15 to 40°. Thus, the side faces 64 extend at an incline with respect to the eye area 28. As a result, the side faces are not visible in the illustrations shown in the FIGS. 4 and 7, each of them appearing in the form of a line in the illustration. In the illustration shown in the FIGS. 5 and 8 as well as in other illustrations they are visible though. As shown in the FIGS. 6 and 9, the particular configuration of the side faces 64 makes it possible for a stirrup strap 62 located in the eye 29 to extend perpendicular to the longitudinal plane 34. Together with the eye area 28, it forms an angle in the range, meaning from 15 to 40° or 90° plus 15 to 40°. The inclined side faces 64 cause the stirrup to be oriented by the stirrup strap 62 or to have a certain rotational orientation.

In a variant of the implementation shown in the FIGS. 10 through 12, it is also possible not to place the extensions 24, 26 with their lower ends butt-jointed onto the carrier part 44 but to configure both parts at least partially to be integral. For this purpose, the extension 24, 26 can be configured to be longer in the bottom part and can be angled 90° in the plane of the carrier part 44 so as to form at least a portion of the carrier part 44.

The German patent application “Stirrup Insert for a Stirrup” of the applicant filed at the same priority date describes the configuration of the rubber insert 50 as it can be seen from the FIGS. 1 through 3. The disclosure of this application is fully incorporated herein by reference.

1-10. (canceled)

11. A stirrup comprising a tread and an arch, said arch being connected to said tread, said arch having two lateral extensions and one upper eye area, an eye being provided in said upper eye area, wherein said eye area extends at an angle of 15 to 40° to a longitudinal plane, said longitudinal plane being defined by a longitudinal axis of the tread and extending at a right angle to said tread.

12. The stirrup as set forth in claim 11, wherein said eye has an eye center that lies on said longitudinal plane.

13. The stirrup as set forth in claim 11, wherein said eye is configured to be a long hole and has a width and a height, said width being at least twice said height.

14. The stirrup as set forth in claim 11, wherein said eye area lies in a plane.

15. The stirrup as set forth in claim 11, wherein each extension has a curvature.

16. The stirrup as set forth in claim 11, wherein each extension has a curvature and said curvature is formed between a hinge region and said eye area.

17. The stirrup as set forth in claim 11, wherein in either of the two lateral extensions there is provided a hinge region, said hinge region comprising swivel axes extending in said longitudinal plane.

18. The stirrup as set forth in claim 11, wherein said eye has an inner wall, said inner wall extending in the y-z plane.

19. The stirrup as set forth in claim 11, wherein said eye area extends at an angle of about 25° to said longitudinal plane.

20. The stirrup as set forth in claim 11, wherein said eye is configured to be a long hole and a width and a height, said width being at least about 5 times its height.

21. The stirrup as set forth in claim 15, wherein said two extensions have the same curvature.

22. A pair of stirrups comprising two stirrups each comprising a tread and an arch, said arch being connected to said tread, said arch having two lateral extensions and one upper eye area, an eye being provided in said upper eye area, wherein said eye area extends at an angle of 15 to 40° to a longitudinal plane, said longitudinal plane being defined by a longitudinal axis of the tread and extending at a right angle to said tread; wherein a left stirrup comprises an eye area that, when the stirrup is viewed from the top, is oriented plus 15 to 40° with respect to said longitudinal plane and a right stirrup comprises an eye area that, when the stirrup is viewed from the top, is oriented minus 15 to 40° with respect to said longitudinal plane, the direction of rotation always being given in the positive mathematical sense.

23. A pair of stirrups as set forth in claim 22, wherein said eye area of said left stirrup is oriented about plus 25° with respect to said longitudinal plane and said eye area of said right stirrup is oriented minus 25° with respect to said longitudinal plane.

24. The stirrup as set forth in claim 22, wherein each hinge region further comprises two opposing connecting regions and connecting parts interposed between said connecting regions.

25. The stirrup as set forth in claim 17, wherein each hinge region further comprises two opposing connecting regions and connecting parts interposed between said connecting regions.
